(19) United States
(12) Patent Application Publication
(10) Pub. No.: US 2018/0077617 A1
(43) Pub. Date: Mar. 15, 2018

(54) Wireless Communication Enhancements for Unmanned Aerial Vehicle Communications

(71) Applicant: QUALCOMM Incorporated, San Diego, CA (US)

(72) Inventors: Qi Xue, San Diego, CA (US); Venkat Venkatachalam Jayara, San Diego, CA (US)

(21) Appl. No.: 15/463,984

(22) Filed: Mar. 20, 2017

Related U.S. Application Data
(60) Provisional application No. 62/385,862, filed on Sep. 9, 2016.

(51) Int. Cl. H04W 36/06; H04B 17/318; H04W 72/04; H04W 64/00; H04W 48/16; H04L 12/26

(52) U.S. Cl. CPC H04W 36/06; H04B 17/318; H04W 72/0453; H04L 43/16; H04W 48/16; H04L 43/0823; H04W 64/003

(57) ABSTRACT

Various embodiments include methods of managing wireless communications between an unmanned aerial vehicle (UAV) and a controller of the UAV. The methods may include determining whether an indicator of current channel conditions for wireless communications over a first channel equals or exceeds a channel impairment threshold. The indicator of current channel conditions may include at least one of a Doppler speed or a distance between the UAV and the controller. The methods may also include changing from the first channel to a second channel for the wireless communications in response to determining that the indicator of current channel conditions for the wireless communications over the first channel equals or exceeds the channel impairment threshold.

### RELATED APPLICATIONS

This application claims the benefit of priority to U.S. Provisional Patent Application 62/385,862 entitled “Wireless Communication Enhancements for Unmanned Aerial Vehicle Communications” filed Sep. 9, 2016, the entire contents of which are incorporated herein by reference.

### BACKGROUND

Unmanned vehicles, such as unmanned aerial vehicles (UAVs), also referred to as “drones,” are used for military, government, commercial/industrial, and/or leisure applications, such as search and rescue, surveillance, weather monitoring, geographical mapping, agriculture, and firefighting. In many implementations, telemetry and/or video captured by a camera on a UAV is transmitted in real time to a control unit operated by a user via a wireless data link. Some wireless local area network (WLAN) communication protocols, such as the Wi-Fi wireless communication protocol, provide a convenient wireless data link for UAVs given the common use of the technology, commercial availability of low cost transceivers, and suitability of the protocols for video content transmissions. However, WLAN communication protocol standards like the Wi-Fi wireless communication protocol standards, were developed for stationary access points and client devices, and do not include provisions for accommodating effects of Doppler frequency shifts experienced when there is relative motion between a transmitting device and a receiving device.

### SUMMARY

Various embodiments include methods, devices, and systems for managing wireless communications between a transmitting device and a receiving device, such as managing wireless communications between an unmanned aerial vehicle (UAV) and a controller of the UAV, based upon the relative motion between the two devices. Various embodiments may include determining whether an indicator of current channel conditions for wireless communications over a first channel equals or exceeds a channel impairment threshold, in which the indicator of current channel conditions may include a mobility indication of at least one of relative movement, such as Doppler speed, and/or a distance between the UAV and the controller, and changing the first channel to a second channel for the wireless communications in response to determining that the indicator of current channel conditions over the first channel equals or exceeds the channel condition threshold.

Some embodiments may further include determining a location of at least one of the UAV and the controller, in which the Doppler speed or the distance between the UAV and the controller may be determined based on the determined location of the at least one of the UAV and the controller.

Some embodiments may further include receiving sensor data from a UAV sensor providing a measure of current channel conditions, and determining the Doppler speed or the distance between the UAV and the controller based on the received sensor data.

Some embodiments may further include determining, while the UAV is using a 2.4 GHz frequency band for communications, whether the Doppler speed is below a 5 GHz Doppler speed limit, and determining whether a request-to-send (RTS) failure rate is greater than an RTS failure rate threshold or a packet failure rate is greater than a packet failure rate threshold. In such embodiments, changing from the first channel to the second channel for the wireless communications may include changing to another operating frequency band in response to determining that the Doppler speed, while the UAV is operating at the 2.4 GHz frequency band, is below the 5 GHz Doppler speed limit and the RTS failure rate is greater than the RTS failure rate threshold or the packet failure rate is greater than the packet failure rate threshold. Such embodiments may further include determining a switch count of times the first channel has been switched on the 2.4 GHz frequency band within a predetermined period, wherein changing from the first channel to the second channel is performed further in response to the determined switch count equaling or exceeding a maximum switching threshold.

In some embodiments, the indicator of current channel conditions may include at least one communication metric selected from the group including a request to send failure rate, a Physical Layer Convergence Procedure (PLCP) protocol data unit failure rate, a media access control protocol data unit packet error rate, an average modulation and coding scheme, or received signal strength indicator.

Some embodiments may further include scanning at least one channel other than the first channel, and determining whether a condition of wireless communications over the at least one channel other than the first channel equals or exceeds the channel impairment threshold.

Some embodiments may include determining whether a channel switching counter-indicator has been detected, wherein changing the first channel of the wireless communications is further in response to not determining the channel switching counter-indicator has been detected. In such embodiments, the channel switching counter-indicator may include at least one of a switch count that equals or exceeds a maximum switching threshold, and a received signal strength indicator (RSSI) at the UAV that does not equal or exceed a UAV RSSI Threshold.

Some embodiments may further include determining whether a received signal strength indicator (RSSI) at the UAV operating at a 5 GHz frequency band equals or exceeds a UAV RSSI threshold, and changing from the first channel to the second channel in response to determining that the RSSI at the UAV operating at another operating frequency band equals or exceeds the UAV RSSI threshold if: the Doppler speed of the UAV is higher than a 5 GHz Doppler speed limit; or an average modulation and coding scheme (MCS) is below an MCS threshold with an average packet error rate (PER) higher than a PER threshold.

Some embodiments may further include transmitting information from the UAV to the controller in one or more transmission frames including at least one of a channel switch announcement (CSA) and an extended CSA element in a transmission frame. Some embodiments may further include transmitting a first series of beacon signals with a first interval therebetween for a predetermined period after which a second series of beacon signals is transmitted with a second interval therebetween that is longer than the first interval, wherein the first series of beacon signals are transmitted immediately in response to changing from the first channel to the second channel.

Some embodiments may further include determining whether the controller received at least one of a channel switch announcement (CSA) and an extended CSA element, in which changing from the first channel to the second channel for the wireless communications may be performed further in response to determining that the controller received at least one of the CSA and the extended CSA element.

Further embodiments include a UAV having a processor configured to execute operations of the methods summarized above. Further embodiments include a UAV having means for performing functions of the methods summarized above. Further embodiments include a non-transitory processor-readable storage medium having stored thereon processor-executable instructions configured to cause a processor to perform operations of the methods summarized above.

### BRIEF DESCRIPTION OF THE DRAWINGS

The accompanying drawings, which are incorporated herein and constitute part of this specification, illustrate exemplary embodiments, and together with the general description given above and the detailed description given below, serve to explain the features of the various embodiments.

FIG. 1 is a schematic perspective view of a UAV and a controller illustrating changes in current channel conditions for wireless communications observed from changes in position of the UAV.

FIG. 2A is a graph illustrating basic service set identifications (BSSIDs) visible by a UAV as a function of frequency (in GHz) at ground level and a 100 foot elevation.

FIG. 2B is a graph illustrating channel occupancy detected by a UAV as a function of frequency (in GHz) at ground level and a 100 foot elevation.

FIG. 3A is a graph illustrating an RSSI plot at ground level.

FIG. 3B is a graph illustrating an RSSI plot at a 100 foot elevation.

FIG. 4 is a component block diagram of a UAV including command-and-control components suitable for use with various embodiments.

FIG. 5 is a process flow block diagram of a UAV control device suitable for use with various embodiments.

FIG. 6A is a process flow diagram illustrating a method of managing wireless communications between a UAV and a controller of the UAV according to some embodiments.

FIG. 6B is a process flow diagram illustrating a method of managing wireless communications between a UAV and a controller of the UAV according to some embodiments.

FIG. 7 is an action frame for an extended channel switch announcement, according to various embodiments.

FIG. 8 is a process flow diagram illustrating a method of channel switching according to some embodiments.

FIG. 9 is a process flow diagram illustrating a method of channel switching according to some embodiments.

FIG. 10 is an illustration of a wireless sequence according to various embodiments.

FIG. 11 a process flow diagram illustrating a method of channel switching from a controller's perspective according to some embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods and communication devices implementing the methods for improving data communications when a transmitting device is moving with respect to a receiving device or two transceivers are moving relative to one another. Various embodiments may be particularly useful for wireless local area network (WLAN) communications, such as those using a protocol like Wi-Fi communications that was developed for relatively stationary access points and client devices. In addition, various embodiments may be used for managing wireless communications between an unmanned aerial vehicle (UAV) and a UAV controller from an access portal (AP).

Given the availability of unlicensed spectrum in Wi-Fi communications, the prevalence, relative low cost, and relative high data rate of the technology, Wi-Fi communications have become a popular choice for wireless communications between a UAV and a UAV controller. However, the Wi-Fi communication standards, developed for stationary access points and client devices, may not be optimized to address the unique challenges faced by the link between the UAV and the UAV controller when the UAV travels in its common environment and airspeeds. Also, Wi-Fi technology is designed for short range indoor non-line of sight wireless communications that focus on medium sharing between multiple users at high data rates. When using Wi-Fi for UAV communications, end users have experienced issues like unreliable connection, reduced range and poor video quality. Such performance degradation is normally observed when the UAV is operating in high interference environments and/or under high mobility, sudden movements, and direction changes.

In many applications for the various embodiments, data and command information is communicated between two or more devices, which may take turns transmitting and receiving communications via a wireless communication link. Thus, at a first time a first device transmitting data or command signals (and thus functioning as the transmitting device) may be received at a second time by a second device receiving the data or command signals (and thus function as the receiving device). Various embodiments involve methods that may be implemented in a device that is transmitting to enable another device that is receiving to recover the transmitted data more reliably when either or both of the devices are moving relative to one another. Therefore, for the sake of brevity, the device that is implementing an embodiment while transmitting signals is referred to herein as the “transmitting device” while the other device is referred to herein as the “receiving device.”

Transmitting and receiving devices may be transceivers capable to both transmitting and receiving. In many circumstances, radio devices using a wireless communication link will alternatively transmit and receive signals via a radio module (e.g., transmitting an acknowledgement (ACK) message after receiving a stream of packets, pausing to receive an ACK message after transmitting a stream of packets, etc.). Thus, references to transmitting devices and receiving devices are not intended to limit the description or the claims to devices or radio modules to single function radios that only transmit or receive. As a useful example implementation, various embodiments are described using a UAV as the transmitting device and a ground-based controller as the receiving device. However, this is for illustration purposes only. It should be understood that in this example when the controller is transmitting (i.e., acting as a transmitting device), the same performance degradation problem exists in the UAV acting as the receiving device. Thus, the various embodiments may be implemented in both moving and stationary devices using wireless communications. Thus, references to the transmitting device or transmitting radio module, as well as the receiving device or receiving radio module, are not intended to limit the scope of the claims to a particular one or type of device unless specifically recited in the claims.

As used herein, the terms “UAV” and “drone” are used interchangeably to refer to one of various types of unmanned aerial vehicles. UAVs are used as an example of an autonomous or remotely controlled vehicle that may benefit from various embodiments. However, the claims and the description are not limited to unmanned aerial vehicles and may be used in air, land, sea, space, or a combination thereof as autonomously or remotely controlled vehicles traveling relative to a controller. Therefore, the use of UAVs as example embodiments for purposes of describing problems addressed and solutions provided by the claims and/or the various embodiments are not intended to limit the scope of the claims unless specifically recited in claim elements.

As used herein, the term “controller” refers generally to a receiver of wireless transmissions from a UAV, an example which is a user interface that includes user input devices (e.g., a joystick), a display for displaying imagery received from the UAV, and a wireless transceiver for sending commands to the UAV and receiving data, such as video data packets, from the UAV. The various embodiments may be used in any wireless communication situation in which the transmitter of data packets is moving relative to the receiver of the data packets at speeds at which Doppler effects may cause degradation in the reception of information within a frame to be transmitted and impact the communication link. Thus, the claims are not limited to situations in which the receiving device is a remote control interface unless specifically recited in the claims. Thus, the term “controller” is meant to encompass fixed, nearly stationary, and mobile receivers of wireless data signals from a UAV.

As used herein, the term “computing device” refers to an electronic device equipped with at least a processor. Examples of computing devices include processors within a controller and the UAV flight control and/or mission management computer that are onboard the UAV, as well as remote computing devices communicating with the UAV configured to perform operations of the various embodiments. Computing devices implemented in base units may include wireless communication devices (e.g., cellular telephones, wearable devices, smartphones, web-pads, tablet computers, Internet enabled cellular telephones, Wi-Fi® enabled electronic devices, personal data assistants (PDAs), laptop computers, etc.), personal computers, and servers. In various embodiments, computing devices may be configured with memory and/or storage. Additionally, computing devices referred to in the various example embodiments may be coupled to or include wireless communication capabilities implementing various embodiments, such as network transceiver(s) and antenna(s) configured to establish a local area network (LAN) connection (e.g., Wi-Fi® transceivers).

Various embodiments may use the existing design of the physical layer (abbreviated as “PHY”) of Wi-Fi communications to take advantage of its high data rates and well-tested performance in the 2.4 GHz and 5 GHz operating frequency bands. Also, using Wi-Fi communications may enable the use of commercial or off-the-shelf Wi-Fi hardware, which may reduce costs and/or provide a fast-to-market solution for UAV communications. Various embodiments may comply with regional regulations and standards (e.g., the Institute of Electrical and Electronics Engineers (IEEE) Standard 802.11™-2014 and past 802.11 b/g/a/n/ac certifications). In addition, various embodiments may work with either a dedicated controller or a software controller application running over contemporary mobile devices, such as smartphones and tablets.

The various embodiments may determine whether a channel carrying wireless communications has interference and/or congestion in order to dynamically change the channel to avoid the interference and/or congestion. Further improvements may be provided by changing from the current operating frequency band to another operating frequency band.

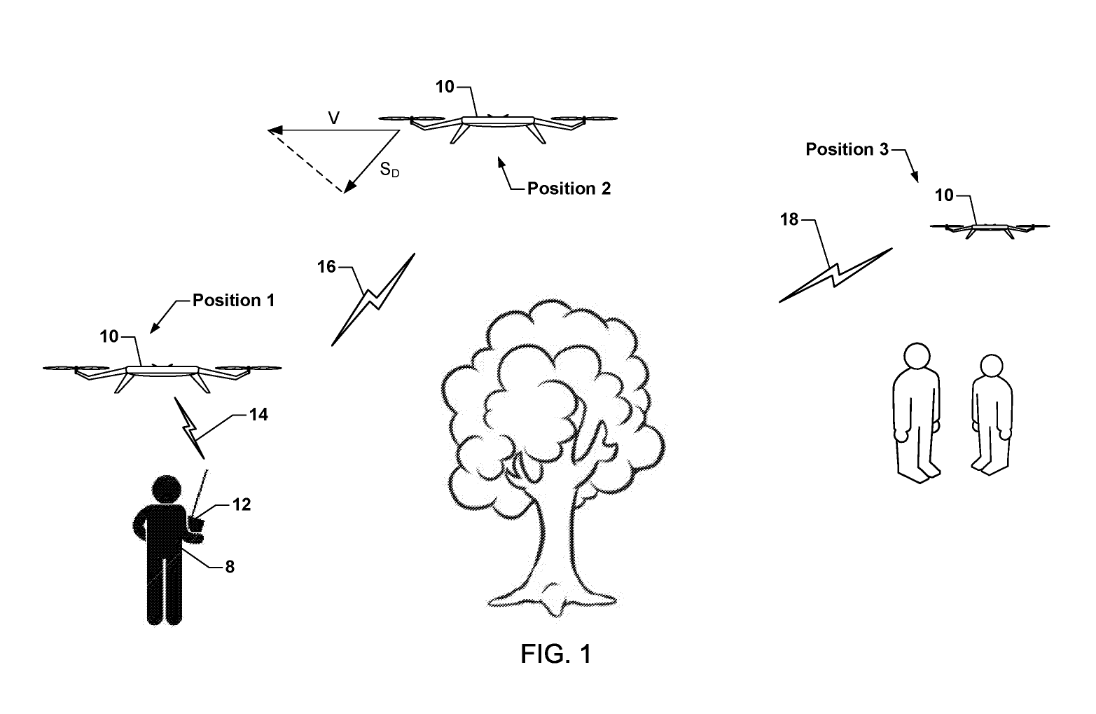

FIG. 1 illustrates a problem that may cause degradation in radio frequency (RF) communications of a communication device, such as a UAV 10, transmitting to a receiving device 12, such as a controller (and vice versa). FIG. 1 illustrates the UAV 10 operated by a user 8 holding the receiving device 12. As the UAV 10 moves to different positions relative to the user 8, the condition of the wireless communications between the receiving device 12 and the UAV 10 may change. For example, the Doppler speed and/or distance between the UAV 10 and the receiving device 12 may impair channel conditions that degrade the RF communications.

FIG. 1 illustrates the UAV 10 traveling toward the user 8 holding the receiving device 12. Generally, the receiving device 12 is relatively stationary, in which case a Doppler speed S_{D} may be measured as a component of the UAV velocity vector V in the direction of the receiving device 12. Otherwise, the velocity vector V and position of the UAV 10 may be determined relative to a receiver device velocity and/or position to determine the Doppler speed S_{D}. As the UAV 10 approaches the user 8 at Position 1, a Doppler speed S_{D} may be zero or nearly zero as the component of the UAV velocity vector V in the direction of the receiving device 12 is small. Thus, during the short time that the UAV 10 takes to travel from Position 2 to Position 1, the Doppler speed changes significantly, appearing to exhibit high deceleration even though the UAV 10 is traveling at a constant speed. In contrast, when the UAV 10 was in Position 3, even if the UAV 10 had been moving at the same velocity as at Position 2, the Doppler speed at Position 3 would have been higher than the Doppler speed S_{D} at Position 2.

The rate of change in the channel characteristics of the wireless communications between the UAV 10 and the receiving device 12 will generally reduce as the distance between the UAV 10 and the receiving device 12 increases. Thus, Doppler affects caused by the speed of the UAV 10 are dynamic depending upon relative speeds (i.e., Doppler speeds), directions, and positions of the UAV 10 and the receiving device 12. Consequently, a static correction for Doppler affects may be overly conservative for one frame and excessively aggressive for the next.

In Position 1, the UAV 10 is flying low and near the receiving device 12 maintaining wireless communications through first wireless signals 14. In Position 2, the UAV 10 is flying higher and further away from the receiving device 12 maintaining wireless communications through second wireless signals 16. In Position 3, the UAV 10 is flying far from and no longer within line of sight of the receiving device 12 maintaining wireless communications through wireless signals 18. The condition of the wireless communications at Position 1, Position 2, and/or Position 3 may be different from one another.

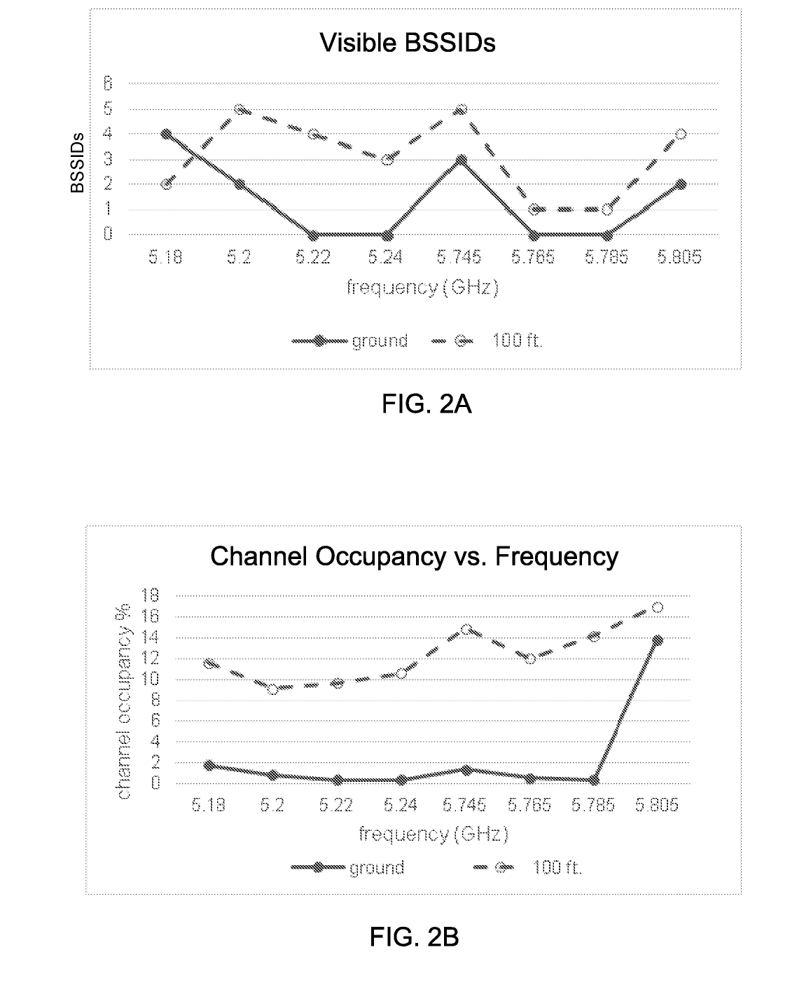

Operating in the air, the UAV 10 may experience very different channel conditions and interference than the receiving device 12 on the ground. As a result, the UAV-controller link may be vulnerable to both hidden node problems as well as exposed node problems in Wi-Fi. FIG. 2A illustrates that a UAV operating high up in the open sky normally sees more nearby Wi-Fi networks than the controller on the ground. With reference to FIGS. 1-2A, the basic service set identifications (BSSIDs) seen (i.e., BSSIDs visible) by the UAV and the controller may be quite different. As such, a “hidden node problem” often exists in Wi-Fi networks, which may cause a high probability of packet collisions. The hidden node problem may occur when a sender is transmitting to a receiver while there is a third device that can be heard by the receiver but cannot be heard by the sender (hence hidden to the sender). When the sender and the “hidden” device transmit at the same time, it leads to collisions at a receiver.

FIG. 2B illustrates that the UAV may face a more crowded channel than the controller and is more likely to be over suppressed by other wireless devices in its vicinity. In particular, FIG. 2B shows measurement results, where the channel occupancy (defined as the percentage of time a channel is busy) is mostly ˜1% on ground level but increases to ˜10% or more at 100 ft. altitude across all channels.

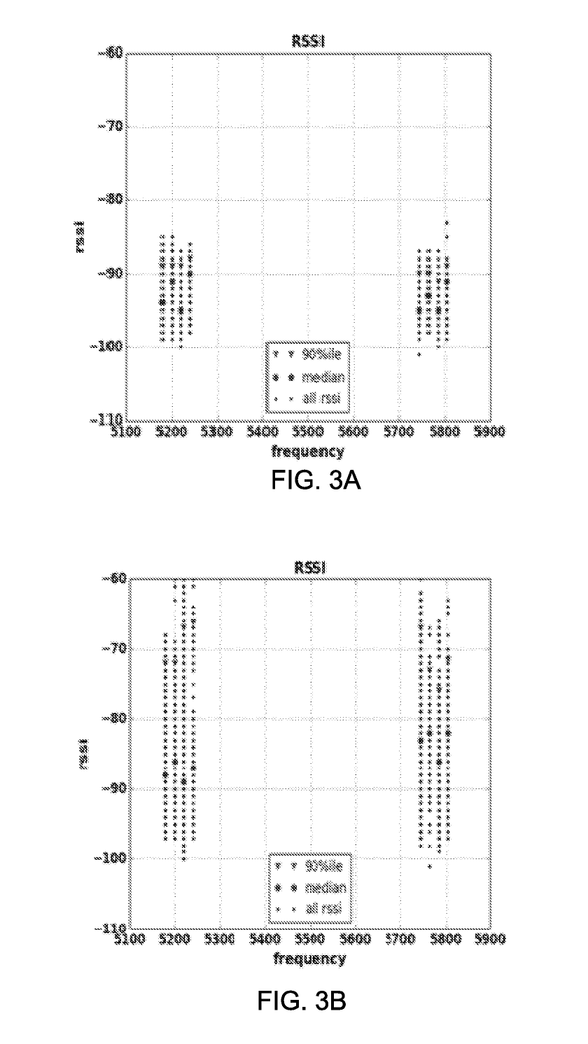

When operating at high altitude in open sky, the UAV may not only see more Wi-Fi networks but also pick up stronger interfering signal levels in its vicinity. FIGS. 3A and 3B illustrate the ninetieth percentile of the received signal strength indicator (RSSI) observed by the UAV may increase from ˜88 dBm on the ground to around ˜68 dBm at approximately 100 ft. altitude. In particular, FIG. 3A illustrates a channel RSSI plot at ground level and FIG. 3B illustrates a channel RSSI plot at 100 feet above ground level.

FIGS. 3A and 3B demonstrate that the UAV may face a more crowded channel than the controller and is more likely to be over suppressed by other wireless devices in its vicinity. In particular, FIGS. 3A and 3B illustrate that the channel occupancy (defined as the percentage of time channel is busy) is mostly ˜1% at ground level but increases to ˜10% or more at an altitude of 100 ft. across all channels.

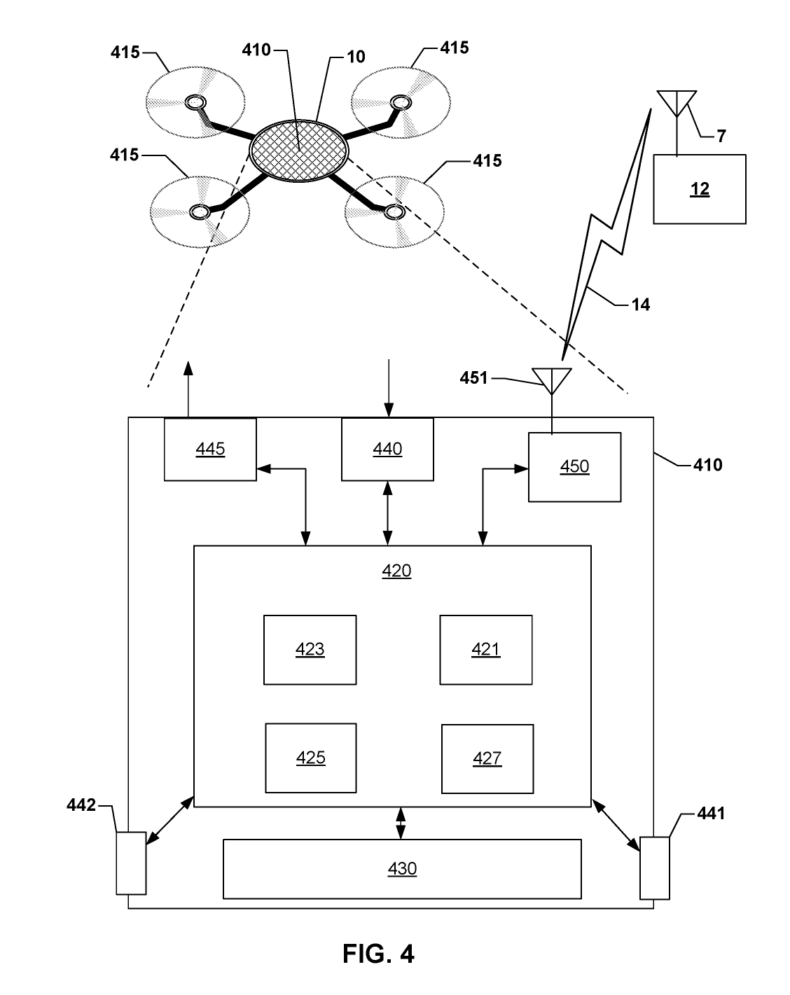

FIG. 4 illustrates a configuration of the UAV 10 that may implement various embodiments. With reference to FIGS. 1-4, the UAV 10 may include a control unit 410 that may house various circuits and devices used to power and control the operation of the UAV 10, as well as any other UAVs controlled by the UAV 10. The control unit 410 may include a processor 420, a power module 430, an input module 440, a camera 441, sensor(s) 442, an output module 445, and a radio module 450 coupled to an antenna 451. The processor 420 may include or be coupled to memory 421 and a navigation unit 423. The processor 420 may be configured with processor-executable instructions to control flight and other operations of the UAV 10, including operations of the various embodiments.

The processor 420 may be coupled to one or more camera 441 and sensor(s) 442. The camera 441 may include one or more image capturing devices. More than one image capturing device may be configured to contemporaneously capture two different images including the target.

The sensor(s) 442 may be optical sensors (e.g., light meters for controlling exposure and determining whether additional illumination is required), radio sensors, a rotary encoder, pressure sensors (i.e., for detecting wind, lift, drag, or changes therein) or other sensors. Alternatively or additionally, the sensor(s) 442 may be contact or pressure sensors that may provide a signal that indicates when the UAV 10 has landed.

The power module 430 may include one or more batteries that may provide power to various components, including the processor 420, the input module 440, the sensor(s) 442, the output module 445, and the radio module 450. In addition, the power module 430 may include energy storage components, such as rechargeable batteries. The processor 420 may be coupled to an output module 445, which may output control signals for managing the motors that drive the rotors 415 and other components.

Through control of the individual motors of the rotors 415, the UAV 10 may be controlled in flight. The processor 420 may receive data from the navigation unit 423 and use such data in order to determine the present position and orientation of the UAV 10, as well as the appropriate course towards the target. In addition, the processor 420 may use such data from the navigation unit 423 to determine a relative position and relative velocity (i.e., Doppler speed) relative to the receiving device 12). In various embodiments, the navigation unit 423 may include a global navigation satellite system (GNSS) receiver system (e.g., one or more Global Positioning System (GPS) receivers) enabling the UAV 10 to determine its location and velocity using GNSS signals received from three or more GNSS satellites (e.g., GPS satellites). Alternatively or in addition, the navigation unit 423 may be equipped with radio navigation receivers for receiving navigation beacon (e.g., very high frequency (VHF) Omni Directional Radio Range (VOR) beacons)s, GPS error/bias broadcasts or other signals from radio nodes, Wi-Fi access points, cellular network sites, radio stations, remote computing devices, other UAVs, etc.

The processor 420 and/or the navigation unit 423 may be configured to communicate with a server through a wireless connection (e.g., a cellular data network) to receive commands useful in navigation, provide real-time position altitude reports, and assess data. An avionics module 427 coupled to the processor 420 and/or the navigation unit 423 may be configured to provide flight control-related information such as altitude, attitude, airspeed, heading and similar information that the navigation unit 423 may use for navigation purposes, such as dead reckoning between GNSS position updates. The avionics module 427 may include or receive data from a gyro/accelerometer unit 425 that provides data regarding the orientation and accelerations of the UAV 10 that may be used in navigation and positioning calculations, as well as some of the embodiments.

The radio module 450 may be configured to receive signals via the antenna 451, such as command signals to perform various flight maneuvers, receive signals from aviation navigation facilities, etc., and provide such signals to the processor 420 and/or the navigation unit 423 to assist in operation of the UAV 10. In some embodiments, commands for navigating the UAV 10, or components thereof may be received via the radio module 450. In some embodiments, the UAV 10 may receive signals from the receiving device 12 via uplink signals sent, from an antenna 7, via the wireless signals 14. When sending uplink signals, the roles are reversed and the UAV 10 becomes the receiving device and the controller that was a receiving device 12 becomes the transmitting device.

In some embodiments, the radio module 450 may be configured to switch between a cellular connection and a Wi-Fi or other form of radio connection depending on the location and altitude of the UAV 10. For example, while in flight at an altitude designated for UAV traffic, the radio module 450 may communicate with a cellular infrastructure in order to maintain communications with a server. In addition, communications with the receiving device 12 may be established using cellular telephone networks while the UAV 10 is flying out of line-of-sight with the user 8 and receiving device 12. Communication between the radio module 450 and the operator communication link may transition to a short-range communication link, such as the wireless signals 14 (e.g., Wi-Fi), when the UAV 10 moves closer to the receiving device 12. Similarly, the UAV 10 may include and employ other forms of radio communication, such as mesh connections with other UAVs or connections to other information sources (e.g., balloons or other stations for collecting and/or distributing weather or other data harvesting information).

In various embodiments, the control unit 410 may be equipped with the input module 440, which may be used for a variety of applications. For example, the input module 440 may receive and pre-process images or data from an onboard component, such as sensor(s), or may receive electronic signals from other components (e.g., a payload). The input module 440 may receive an activation signal for causing actuators on the UAV 10 to deploy landing cushions or similar components for affecting an emergency landing. In addition, the output module 445 may be used to activate components (e.g., an energy cell, an actuator, an indicator, a circuit element, a sensor, and/or an energy-harvesting element). In addition, the control unit 410 may include integrated components, such as a camera 441 or sensor(s) 442, which may also provide data to the processor 420.

Utilizing sensor data (e.g., speed, orientation and acceleration) available from onboard components, the control unit 410 using the processor 420 may determine a current position, which may be used to mitigate Doppler effects associated with high mobility. Speed, orientation, and acceleration are types of sensor data that may be used to extrapolate a current position of the UAV 10, such as relative to the receiving device 12. Such sensor data may be combined with last known position information to determine the Doppler speed of the UAV 10 relative to the receiving device 12. Last known position information may be obtained when adjacent the receiving device 12, from a GNSS or other navigation system, or from other received inputs. This may assume the receiving device 12 is relatively stationary or incorporate last known movement information associated with the receiving device 12. Once the processor 420 determines a current position of the UAV 10 and the receiving device 12 (i.e., controller), a line-of-sight (LOS) distance or changes in the LOS distance between the UAV 10 and receiving device 12 may be calculated. Thus, the processor 420 may utilize a determination of changing LOS distance to proactively change a wireless communication configuration, such as a current communication channel, in order to improve or maintain a more reliable communication link.

While the various components of the control unit 410 are illustrated in FIG. 4 as separate components, some or all of the components (e.g., the processor 420, the output module 445, the radio module 450, and other units) may be integrated together in a single device or module, such as a system-on-chip (SoC).

For ease of description and illustration, some detailed aspects of the UAV 10 are omitted, such as wiring, frame structure, power source, landing columns/gear, or other features that would be known to one of skill in the art. In addition, although the example UAVs are illustrated as quad copters with four rotors, the UAVs may include more or fewer than four rotors. Also, the UAV 10 may have similar or different configurations, numbers of rotors, and/or other aspects.

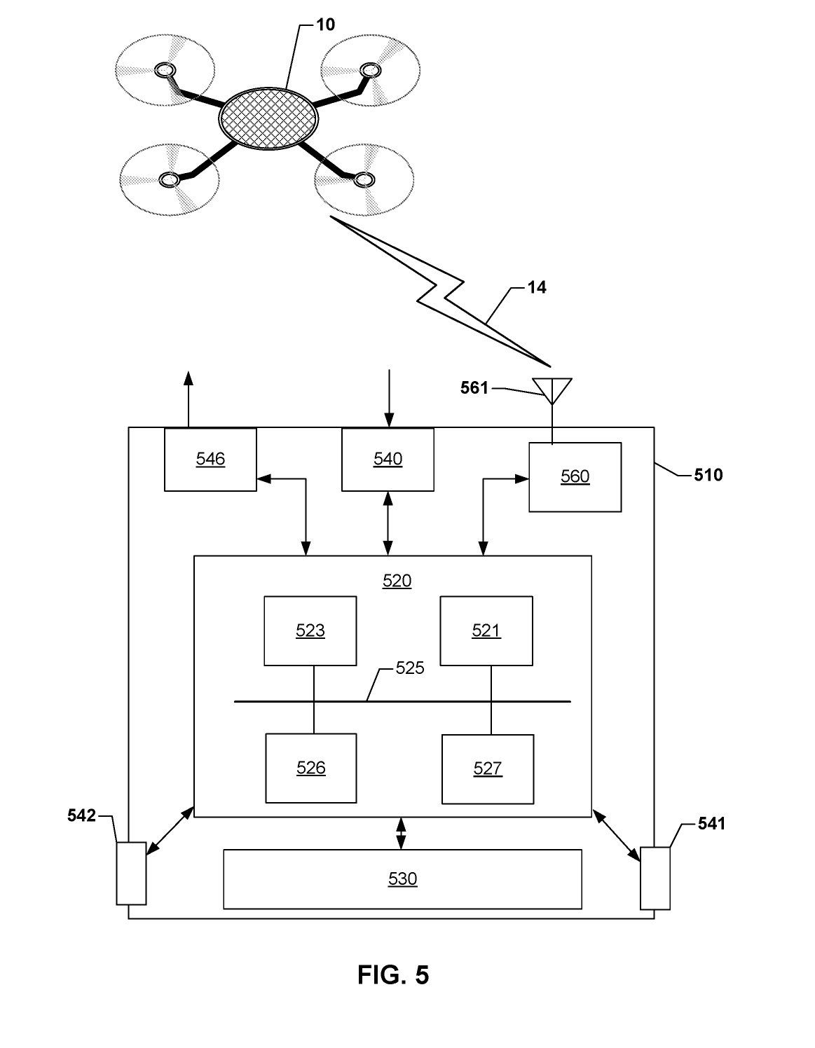

FIG. 5 illustrates components of a receiver device 510 (e.g., a video receiver or UAV controller such as the receiver device 12 in FIGS. 1 and 4) suitable for use with the various embodiments. With reference to FIGS. 1-5, the receiver device 510 may include a computing device 520 coupled to a transceiver 560 configured to send and receive wireless signals 14 via an antenna 561. The computing device 520 may include a processor 521, memory 523, and various other components, such as a graphics processor 526 and a digital signal processor 527, communicatively connected via a bus 525 or other inter-module communication circuits. The receiver device 510 may also include a battery 530 or other power system coupled to the computing device 520. User inputs 541, 542, such as button, knobs, and joysticks may receive inputs from a user, and provide such inputs to the computing device extended 20, such as for sending control commands to a UAV 10. A receiver device 510 may also include various network interfaces 546 for receiving inputs from other computing devices. A receiver device 510 may also include a large storage memory, such as a disc drive 540 or flash memory for storing data (e.g., video frames) received from the UAV 10.

In various embodiments, to avoid persistent interference or congestion in a communication channel, a processor of the UAV 10 may dynamically change a current operating channel to find a less congested channel Additionally, the UAV 10 may switch the current operating frequency band to another operating frequency band (e.g., between 5 GHz and 2.4 GHz) for performance tradeoff between Doppler speed, range, and interference.

Due to the mobility of the UAV 10, the channel condition between the UAV 10 and the controller tends to change over time. For example, the UAV 10 may select a light loaded channel (i.e., a channel with little interference and/or congestion) upon start up. However, as the UAV 10 moves to a different location, the operating channel may become busy (i.e., congested) due to nearby Wi-Fi networks in the new location. Often, the signals carrying the wireless communications between UAV 10 and the controller may suffer from persistent collisions due to hidden nodes as the UAV 10 moves into a new location. Thus, in accordance with various embodiments, a processor of the UAV 10 may monitor, regularly or continuously, one or more indicators of current channel conditions for wireless communications to make sure conditions meet a minimum channel condition threshold.

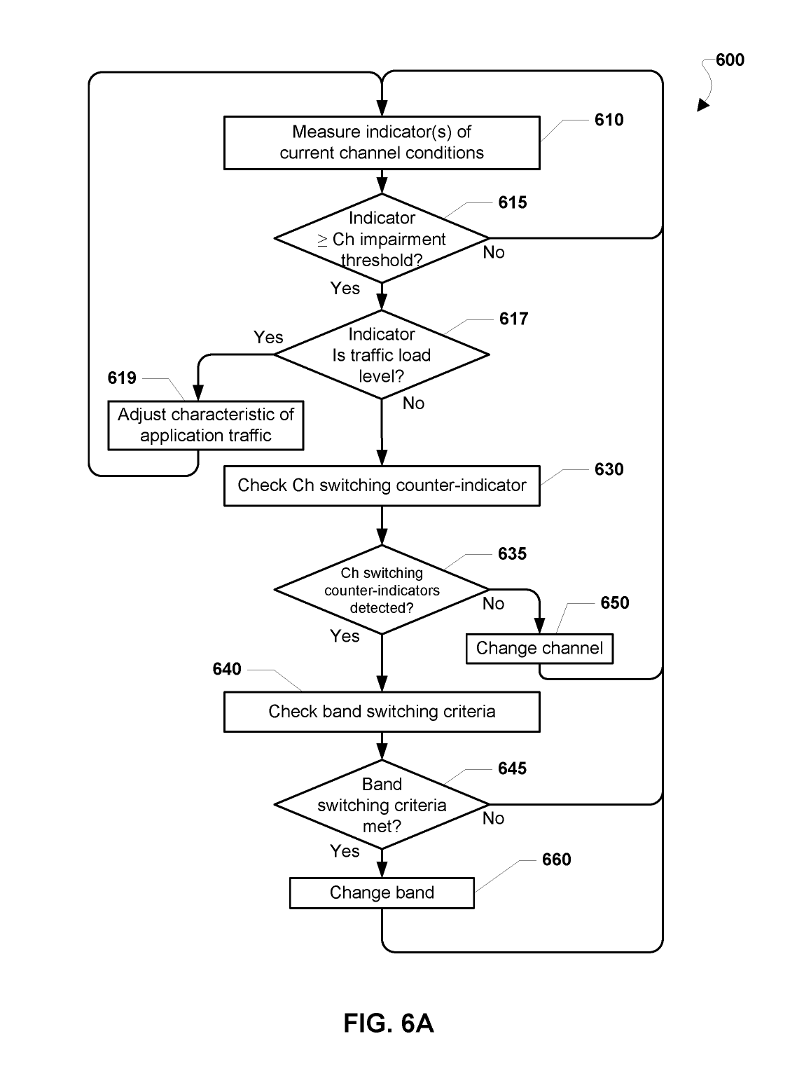

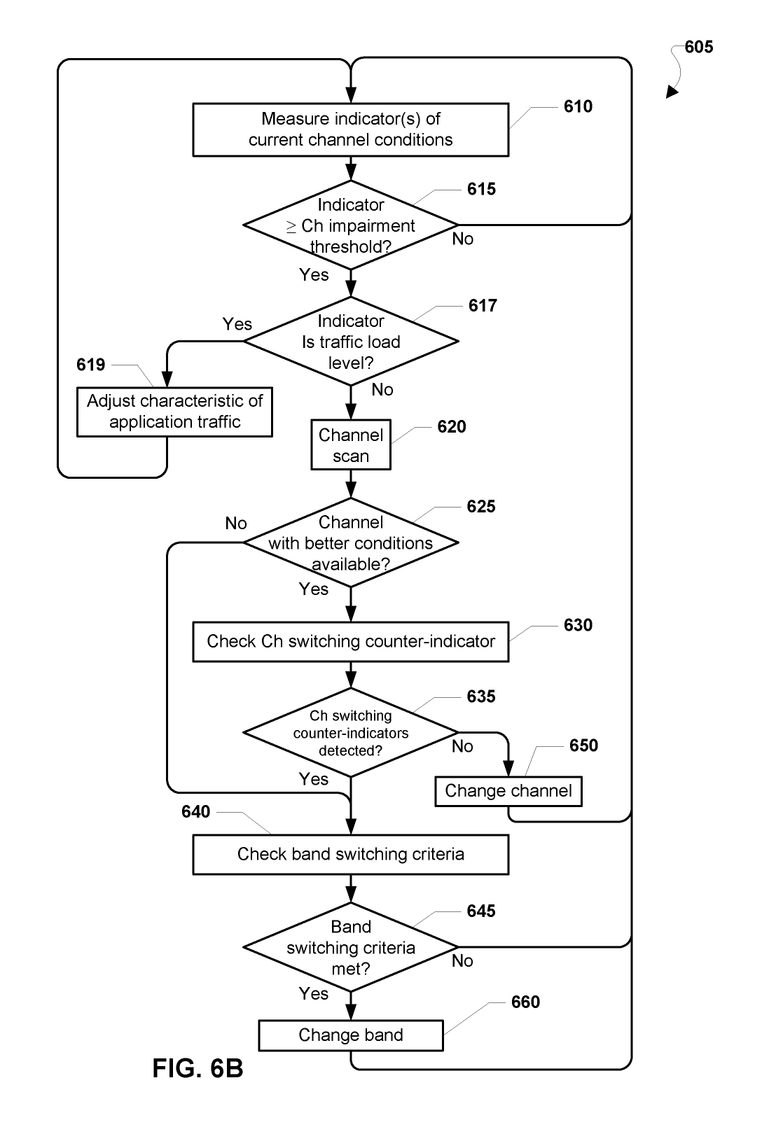

FIG. 6A illustrates a method 600 of managing wireless communications between a UAV and a controller of the UAV. With reference to FIGS. 1-6A, the operations of the method 600 may be implemented in a processor of a moving transmitting device (e.g., the processor 420 of the UAV 10) or transmitting radio module therein (e.g., 450), or in a receiving device (e.g., the processor 421 of the receiver device 410 or 12) in communication with the transmitting device. Channel switching within a current operating band may be triggered if performance of the UAV is or may be impacted by factors such as a level of traffic load of communications between the UAV and the controller, communication interference, and/or hidden nodes that are specific to a current operating channel. For example, the level of traffic load may impact the decision to switch channels when communication throughput limits are reached and application traffic (e.g., a live video feed from the UAV) starts competing with operational safety communications needed to safely fly the UAV.

In block 610, the processor may measure, continuously or at intervals, one or more indicators of current channel conditions. The indicator(s) may reflect a metric of current channel conditions and may be averaged over a time window of a particular duration (e.g., “SAMPLE DURATION”). In particular, the indicator(s) may include a Doppler speed or a distance between the UAV and the controller. The Doppler speed or the distance between the UAV and the controller may be determined based on a determined GNSS location of the UAV and/or the controller. The GNSS location may be determined using a conventional GNSS receiver. Additionally or alternatively the GNSS location may be determined using enhanced navigation systems, such as enhanced GPS (E-GPS), which exploits data available from cellular networks to speed GPS fixes and provide complementary, fast, and reliable location sensing when GPS signals are weak or unavailable. The indicator(s) of current channel conditions may include (but is not limited to) one or more of the following metrics:
Request to send (RTS) failure rate, which is a ratio of failed RTS transmissions;
Presentation Protocol Data Unit (PPDU) failure rate, which is a ratio of failed PPDU transmissions;
Media access control protocol data unit (MPDU) packet error rate (PER) of the MPDUs;
An average modulation and coding scheme (MCS) used;
A level of traffic load approaching or reaching a communications throughput limit; and/or
A received signal strength indicator (RSSI), which may reflect a signal strength of the received packets from controller in dBm.

Each of the above-noted indicators may be associated with a channel (Ch) impairment threshold. The channel impairment threshold may reflect a value at or above which current channel conditions may be considered unsatisfactory. Thus, if an indicator of current channel conditions equals or exceeds the channel impairment threshold, current channel conditions may be considered significantly impaired. Table 1-1 below is an example of parameters that may be used for the channel impairment threshold in accordance with various embodiments.

TABLE 1-1

| | Ch impairment | | |
|---|---|---|---|
| Indicator | threshold | Range | Description |
| RTS_FAILURE_RATE | 80% | [0, 100%] | Percentage of RTS |
| | | | transmission fails. |
| PPDU_FAILURE_RATE | 40% | [0, 100%] | Percentage of PPDU |
| | | | transmission fails. |
| UAV_RSSI | −80 dBm | [0, −96 dBm] | RSSI threshold for the |
| | | | controller data received by the |
| | | | UAV. |
| DOPPLER_SPEED | 15 m/s | [0 m/s, 30 m/s] | Relative speed between UAV |
| | | | and controller |
| LOS_DISTANCE | 1 km | [0, 3 km] | Distance between UAV and |
| | | | controller |
| TRAFFIC_LOAD_LEVEL | 90% | [0, 100%] | Percentage of throughput limit |
| | | | used by level of traffic load |

In determination block 615, the processor may determine whether the indicator of current channel conditions, measured in block 610, equals or exceeds a channel impairment threshold.

In response to determining that the indicator of current channel conditions for wireless communications over the current channel equals or exceeds the channel impairment threshold (i.e., determination block 615=“Yes”), the processor may determine whether the indicator of current channel conditions is a traffic load level indicator in determination block 617. If more than one indicator of current channel conditions is measured/used in block 610, any one of such indicators that equals or exceeds a corresponding channel impairment threshold may be treated as a determination that the indicator of current channel conditions for wireless communications over the current channel equals or exceeds the channel impairment threshold (i.e., determination block 615=“Yes”). Alternatively, if more than one indicator of current channel conditions is measured/used in block 610, more than one of such indicators may need to equal or exceed a respective channel impairment threshold in order for the processor to determine that the indicator of current channel conditions for wireless communications over the current channel equals or exceeds the channel impairment threshold (i.e., determination block 615=“Yes”).

The traffic load level may impair UAV performance when the amount of traffic communicated between the UAV and the receiving device reaches the communication throughput limit for communications on the current channel Once the communication throughput limit is reached, any additional traffic may either be lost or have to wait to be transmitted. However, if the additional traffic includes operational safety communications, the performance of the UAV may be compromised. Thus, a traffic load level may be designated and monitored as an indicator of current channel conditions in order to avoid impaired UAV performance. The channel impairment threshold, as it relates to the traffic load level, may be a designated percentage (e.g., 90%) of the throughput limits for the current channel.

Operational safety communications may involve telemetry carrying override control commands and UAV status information exchanged between the UAV and the receiving device. For example, the UAV status information may include data regarding the UAV's flight status (e.g., attitude, and speed and direction of motion), current location, current activities, and resource status (e.g., power supply levels). Additionally, operational safety communications may include communications of local air traffic conditions, navigational commands, navigational patterns, or other operational safety information. Since operational safety communications allow the UAV to receive flight control and safety messages and/or instructions that should be received with minimal latency, the operational safety communications may need to comply with specific high-level reliability and regulatory compliance requirements. In contrast to operational safety communications, so-called “application traffic” includes other communications that are not considered operational safety communications of the UAV. For example, application traffic may include communications with equipment on the UAV for managing one or more mission objectives, other than navigating and operational safety. In particular, application traffic may configure a sensor payload for measurements (e.g., agricultural crop yield measurements in agricultural settings) or download collected data files (e.g., video recordings unrelated to vehicle control or safety). Often, the application traffic drives the purpose for the UAV operations but may be completely unrelated to operating the UAV safely or securely. Thus, the application traffic may be directed or managed differently than the operational safety communications.

In response to determining that the indicator of current channel conditions is a traffic load level indicator (i.e., determination block 617=“Yes”), the processor may adjust a characteristic or characteristics of the application traffic communicated over the first channel in block 619. Adjusting the characteristic or characteristics of application traffic may include the processor limiting or changing a maximum throughput rate of application traffic communicated over the first channel. For example, a maximum throughput rate (i.e., a cap) may be set or reduced on traffic related to a live video feed captured by a camera on the UAV that is communicated to the controller. As another example, the resolution or other quality of the live video feed may be reduced as part of changing the characteristic or characteristics of the application traffic. Thus, adjusting the characteristic or characteristics of application traffic may include at least one of changing a target bitrate, resolution, quality, or frame rate of video captured by a camera on the UAV and communicated to the controller in real time. In some embodiments, one or more of a target bitrate, resolution, quality, or frame rate of the video captured by the camera on the UAV may be changed depending upon an amount by which the indicator of current channel conditions for the wireless communications exceeds the channel impairment threshold. In some embodiments in which multiple indicators of current channel conditions are available, particular ones or combinations of targeted bitrate, resolution, quality, or frame rate of the video captured by the camera on the UAV may be changed depending on the current channel condition indicators that equal or exceed a channel impairment threshold. Once the characteristic or characteristics of application traffic is/are changed, the processor may again measure the indicator of current channel conditions in block 610.

In response to determining that the indicator of current channel conditions is not a traffic load level indicator (i.e., determination block 617=“No”), the processor may check for a channel switch counter-indicator in block 630. If more than one indicator of current channel conditions is measured/used in block 610, any one of such indicators that equals or exceeds the channel impairment threshold may be treated as a determination that the indicator of current channel conditions for wireless communications over the current channel equals or exceeds the channel impairment threshold (i.e., determination block 615=“Yes”). Alternatively, if more than one indicator of current channel conditions is measured/used in block 610, more than one of such indicators may need to equal or exceed the respective channel impairment threshold in order for the processor to determine that the indicator of current channel conditions for wireless communications over the current channel equals or exceeds the channel impairment threshold (i.e., determination block 615=“Yes”).

In response to determining that the indicator of current channel conditions for wireless communications over the current channel does not equal or exceed the channel impairment threshold (i.e., determination block 615=“No”), the processor may again measure the indicator of current channel conditions in block 610.

In block 630, the processor may check for a channel switching counter-indicator. The channel switching counter-indicator may prevent a channel switch under certain circumstances in which it may not be desirable to switch channels, even though the processor determined that at least one indicator of current channel conditions over the current channel equals or exceeds the channel impairment threshold (i.e., determination block 615=“Yes”). The channel switching counter-indicator may include (but is not limited to) one or more of the following indications:
A switch count (i.e., a count of times the channel has been switched within a predetermined period—“CHANNEL_SWITCH_WINDOW”) that equals or exceeds a maximum switching threshold. The maximum switching threshold may prevent the processor from switching too often;
Impairment is more likely due to temporary blockage or temporary flight outside of coverage. A temporary blockage or navigation outside of coverage may be detected by an RSSI at the UAV that does not equal or exceed a UAV RSSI Threshold; and
One or more specific packet error rates (i.e., indicators of current channel conditions) does not equal or exceed the channel impairment threshold. For example:
   The request-to-send (RTS) failure rate does not equal or exceed the RTS failure threshold (e.g., see Table 1-1); or
   The PPDU failure rate does not equal or exceed the PPDU failure threshold (e.g., see Table 1-1), which may reflect hidden nodes or other interference that may cause channel fading, erasure, or other communication problems.

In determination block 635, the processor may determine whether channel (Ch) switching counter-indicators were detected in block 630.

In response to determining that no channel (Ch) switching counter-indicators were detected (i.e., determination block 635=“No”), the processor may change the channel in block 650. Specifically, the processor may try to change channels to use a non-overlapping channel (i.e., a channel that does not have overlapping frequency bands, e.g., channel 1, 6, and 11). Additionally, or alternatively, the processor may switch to the least recently used non-overlapping channel within the current operation band. Once the channel is changed in block 650, the processor may again measure the indicator of current channel conditions in block 610.

In response to determining that channel (Ch) switching counter-indicators were detected (i.e., determination block 635=“Yes”), the processor may check operating frequency band (also referred to herein as just “band”) switching criteria in block 640. Band switching may only be available/applicable if the controller allows this function. If band switching is available/applicable, UAVs using Wi-Fi technology may generally operate on either 2.4 GHz or 5 GHz. Due to the high path loss on 5 GHz, 2.4 GHz is normally preferred to improve the range or mobility. On the other hand, there are more non-overlapping channels on 5 GHz (2.4 GHz only has three non-overlapping channels, namely channels 1, 6, and 11) which make it a better choice to avoid interference. Thus, there may be a tradeoff between the range/mobility and interference that informs the processor decision to switch between the 2.4 GHz and 5 GHz bands.

A signal-to-noise ratio (SNR) gain of 2.4 GHz over 5 GHz may be expressed as:

2 GHz_Gain=2 GHz_Power_Gain+2 GHz_PL_Gain (Eq. 1)

In Eq. 1, the 2 GHz_Power_Gain may represent the transmit power difference between 2.4 GHz and 5 GHz, which may be a provisioned value on a UAV. In some regions (e.g., within the USA), a transmit power limit may be the same for 2.4 GHz as it is for 5 GHz, but other regions may allow a higher transmit power limit on one band (e.g., at 5 GHz). The 2 GHz_PL_Gain may represent the path loss difference between 2.4 GHz and 5 GHz, assuming free space path loss, which is 7.5 dB. The resulting 2 GHz_Gain may be a negative value if the maximum allow transmit power on 5 GHz is much higher than 2.4 GHz, which may be true for some regulatory regions (e.g., outside the United States of America).

A UAV may initially (e.g., by default) operate on a least loaded non-overlapping channel on a default frequency band set by the UAV original equipment manufacturer or other entity. Nonetheless, the operating frequency band switching criteria may be different depending on whether the switch is to 2.4 GHz or to 5 GHz. A switch from 5 GHz to 2.4 GHz is often done to accommodate high mobility and better coverage. In contrast, a switch from 2.4 GHz to 5 GHz is often done to avoid congestion and interference.

In accordance with various embodiments, the band switching criteria may be met for a switch from 5 GHz to a random non-overlapping channel in 2.4 GHz under the following conditions:
RSSI at the UAV (currently at 5 GHz)+2 GHz_Gain (calculated per Eq. 1)>The UAV RSSI threshold, which may ensure the signal strength at 2.4 GHz is good enough); and
One of the following additional conditions are met:
   The Doppler speed, if available, is higher than a 5 GHz Doppler speed limit (“5 GHZ_DOPPLER_LIMIT,” such as for example 15 m/s); or
   The average MCS is below an MCS threshold (“MCS_THRESHOLD”) with an average MPDU packet error rate (PER) higher than a PER threshold (“PER_THRESHOLD”).

In various embodiments, the band switching criteria may be met for a switch from 2.4 GHz to a random non-overlapping channel in 5 GHz under the following conditions:
The Doppler speed, if available, is below the 5 GHZ_DOPPLER_LIMIT, which may ensure the Doppler speed is not too high to prohibit operation, and
The RTS failure rate is greater than the RTS_FAILURE_RATE threshold or the PPDU failure rate is greater than PPDU_FAILURE_RATE threshold. (2.4 GHz has fewer non-overlapping channels than 5 GHz, which means it tends to suffer from more interference, thus checking the error rates may prevent an unnecessary switch to a band not likely to improve communications), and
The UAV had MAX_SWITCH_COUNT channel switches on 2.4 GHz within the last CHANNEL_SWITCH_WINDOW, and
RSSI at the UAV−2 GHz_Gain>UAV_RSSI

In determination block 645, the processor may determine whether band switching criteria were met in block 640.

In response to determining that the band switching criteria were met (i.e., determination block 645=“Yes”), the processor may change the operating frequency band in block 660. Once the operating frequency band is changed, the processor may again measure the indicator of current channel conditions in block 610.

In response to determining that the band switching criteria were not met (i.e., determination block 645=“No”), the processor may again measure the indicator of current channel conditions in block 610.

FIG. 6B illustrates a method 605 of managing wireless communications between a UAV and a controller of the UAV according to some embodiments. With reference to FIGS. 1-6B, the operations of the method 605 may be implemented in a processor of a moving transmitting device (e.g., the processor 420 of the UAV 10) or transmitting radio module therein (e.g., 450), or in a receiving device (e.g., the processor 421 of the receiver device 410 or 12) in communication with the transmitting device. In the method 605, the operations of blocks 610-619 and 630-660 may be performed as described for like numbered blocks of the method 600.

In response to determining that the indicator of current channel conditions is not a traffic load level indicator (i.e., determination block 617=“No”), the processor may (e.g., if available or appropriate) initiate a channel scan in block 620.

In block 620, the processor may perform a channel scan to determine whether another channel with better conditions is available. The channel scan may be based on the type of communications currently being transmitted or on the capability of the UAV. For example, the time it takes to switch channels (e.g., 5 ms) may be too long and thus compromise some wireless communications, like a live video feed, which would get interrupted by a channel scan of another channel.

In order to inform a channel switching decision, the processor may need to identify a best channel for the switch. The channel scan in block 620 may be performed using active probing or passive channel monitoring. During active probing, the processor may send out broadcast probe requests and the nearby access points on the channel may individually respond with a probe response. In a passive scan, the processor may listen to the channel by measuring the median utilization of the channel. The median utilization may reflect how often the prospective channel is busy. The processor may reserve passive channel scans for limited circumstances, such as one of the following:
The response time to probe request is limited by the channel condition and access point implementation. Therefore, the UAV may not get the response from all the access points on the channel during the channel scan interval.
Active channel scan with probe request can only detect the access points on the channel, which does not necessarily represent the amount of traffic on the channel.

When the processor, or a UAV Wi-Fi module, is idle and the last scan for any channel is more than a minimum scan interval (“MIN_SCAN_INTERVAL”), the processor may send out a clear-to-send (CTS)-to-self with duration field set to minimum scan duration (“MIN_SCAN_DURATION”) and start a channel scan. The minimum scan duration may be the minimum duration covering the time required to switch to a new channel, perform passive scan on the channel, and switch back. The processor may initiate a scan one channel during each channel scan and scan all the channels within its operating band in a round robin fashion. Also, the processor may maintain a list of channels with the average medium utilization per channel.

In determination block 625, the processor may determine whether a channel with better conditions is available based on the channel scan in block 620.

In response to determining that at least one channel with better conditions is available (i.e., determination block 625=“Yes”), the processor may check for channel (Ch) switch counter-indicators in block 630.

In response to determining that no channel with better conditions is available (i.e., determination block 625=“No”), the processor may check band switch criteria in block 640.

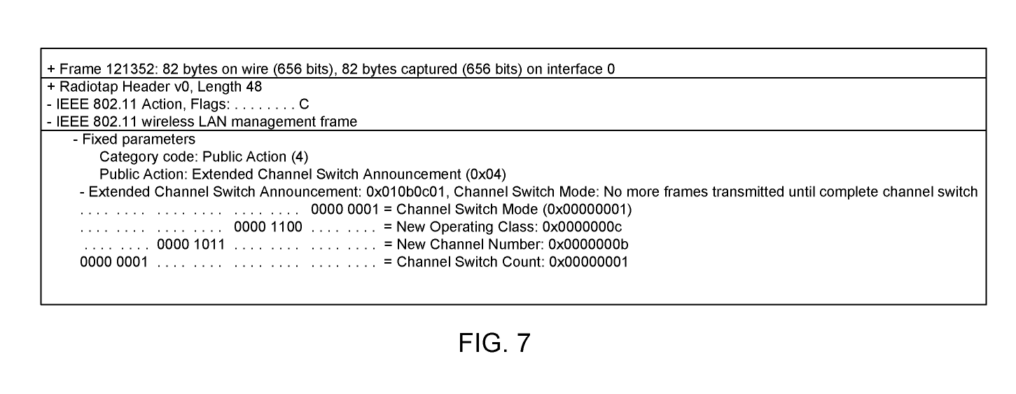

The UAV processor may inform the controller that the UAV is changing to a new channel and maintain the association using channel switch announcement (CSA) elements and extended CSA elements in beacon frames and action frames until the intended channel switch time. An example of an extended CSA action frame is illustrated in FIG. 7. With reference to FIGS. 1-7, the illustrated extended CSA action frame has:
A Channel Switch Mode equal to 1 means that the station shall transmit no further frames until the scheduled channel switch. A Channel Switch Mode equal to 0 does not impose any requirement on the receiving station.
The New Operating Class field is set to the number of the operating class after the channel switch, as defined [1]. The operating class is an index into a set of values for radio operation in a regulatory domain.
The new channel number is the channel index of the new channel
The channel switch count is the number of Target Beacon Transmission Times (TBTT) until the AP switches to the new channel A value of 1 indicates that the switch occurs immediately before the next TBTT. A value of 0 indicates that the switch occurs at any time after the frame containing the element is transmitted.

The UAV and controller may exchange the channel switch capability via a beacon and association request and response procedure.

The UAV, or UAV Wi-Fi module, may set the Extended Channel Switching field to 1 in the extended capabilities element of the beacon frame and association response frame.

The controller, or controller Wi-Fi module, may set the Extended Channel Switching field to 1 in the extended capabilities element of the association request frame, if it supports the extended channel switching operation. If the controller has the extended channel switching field set to 1, the UAV may send the Extended CSA element and frame. Otherwise, the access point may send the Channel Switch Announcement element and frame.

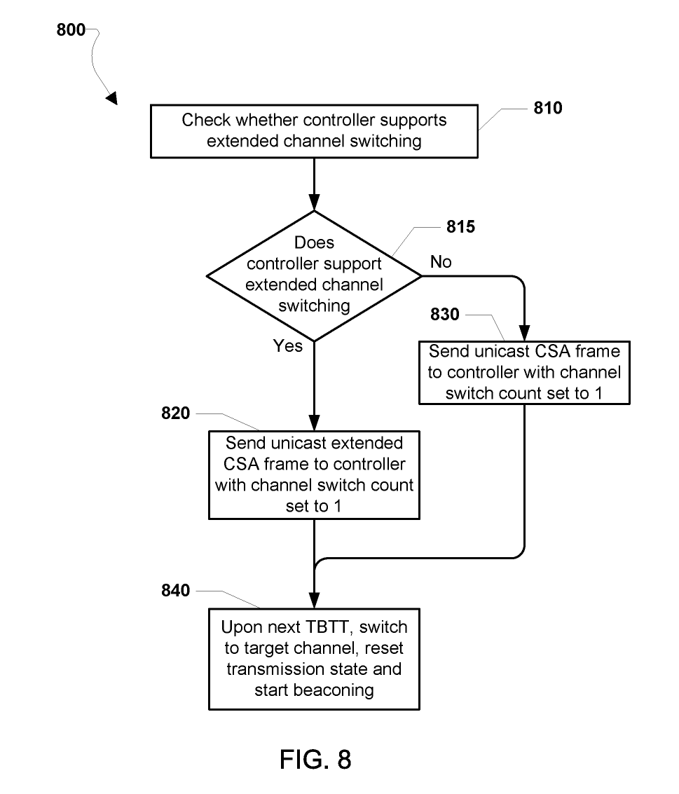

FIG. 8 illustrates a method 800 of managing wireless communications between a UAV and a controller of the UAV. With reference to FIGS. 1-8, the operations of the method 800 may be implemented in a processor of the UAV (e.g., the processor 420 of the UAV 10) or transmitting radio module therein.

In block 810, the processor may check whether the controller supports extended channel switching. Such a check may be performed through a lookup table or query transmitted to the controller. In determination block 815, the processor may determine whether the controller supports extended channel switching based on the check in block 810.

In response to determining that the controller supports extended channel switching (i.e., determination block 815=“Yes”), the processor may send (i.e., transmit) a unicast extended CSA frame to the controller with a channel switch count set to 1 in block 820.

In response to determining that the controller does not support extended channel switching (i.e., determination block 815=“No”), the processor may send (i.e., transmit) a unicast CSA frame to the controller with a channel switch count set to 1 in block 830.

In block 840, upon the next target beacon transmission time (TBTT), the processor my switch to the target channel, reset the transmission state, and start beaconing.

Based on IEEE 802.11, after determining the medium is idle for one point coordination function (PCF) interframe space (PIFS), the UAV may send a CSA or extended CSA frame without performing a backoff. A challenge during the channel switching process is to minimize the disruption to the ongoing traffic between UAV and controller while minimizing the channel switching delay. To improve the reliability of the CSA, the UAV may send unicast action frames for the channel announcement with the channel switch count set to 1. Upon next TBTT, the UAV may switch to the target channel.

Upon channel switching, if UNICAST ECSA ENABLED is set to 1, the UAV Wi-Fi module may follow the method 800.

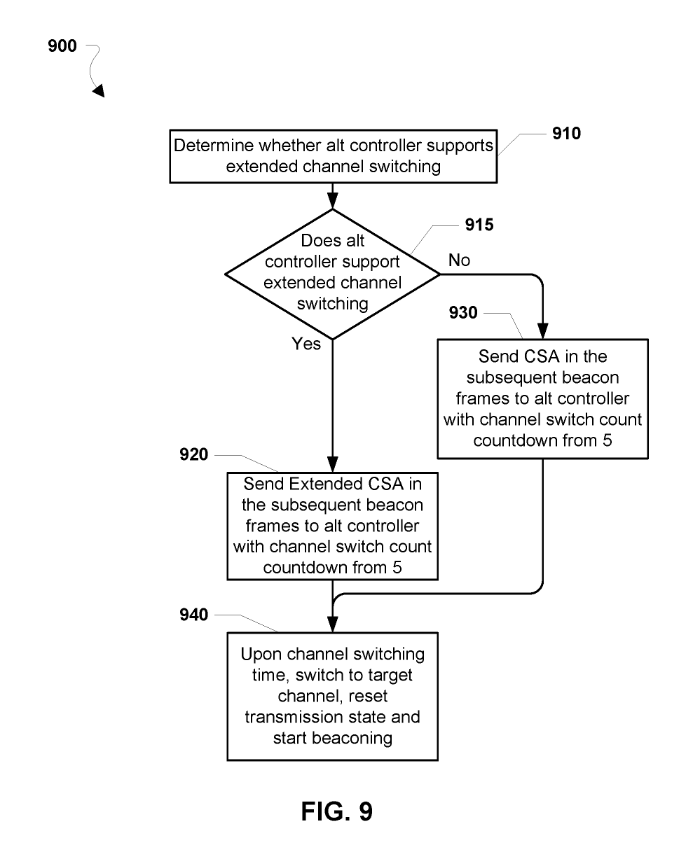

In contrast, upon channel switching, if UNICAST ECSA ENABLED is set to 0, the UAV Wi-Fi module may follow the method 900 of FIG. 9.

FIG. 9 illustrates the method 900 of managing wireless communications between a UAV and an alternative controller of the UAV. With reference to FIGS. 1-9, the operations of the method 900 may be implemented in a processor of the UAV (e.g., the processor 420 of the UAV 10) or transmitting radio module therein. In block 910, the processor may check as to whether the alternative controller supports extended channel switching. Such a check may be performed through a lookup table or query transmitted to the alternative controller. In determination block 915, the processor may determine whether alternative controller supports extended channel switching, based on the check in block 910.

In response to the processor determining the alternative controller supports extended channel switching (i.e., determination block 915=“Yes”), the processor may send (i.e., transmit) extended CSA in the subsequent beacon frames to alt controller with channel switch count set to countdown from 5 in block 920.

In response to the processor determining the alternative controller does not support extended channel switching (i.e., determination block 915=“No”), the processor may send (i.e., transmit) CSA in the subsequent beacon frames to the alternative controller with the channel switch count set to countdown from 5 in block 930.

In block 940, upon channel switching time, the processor may switch to target channel, reset transmission state, and start beaconing.

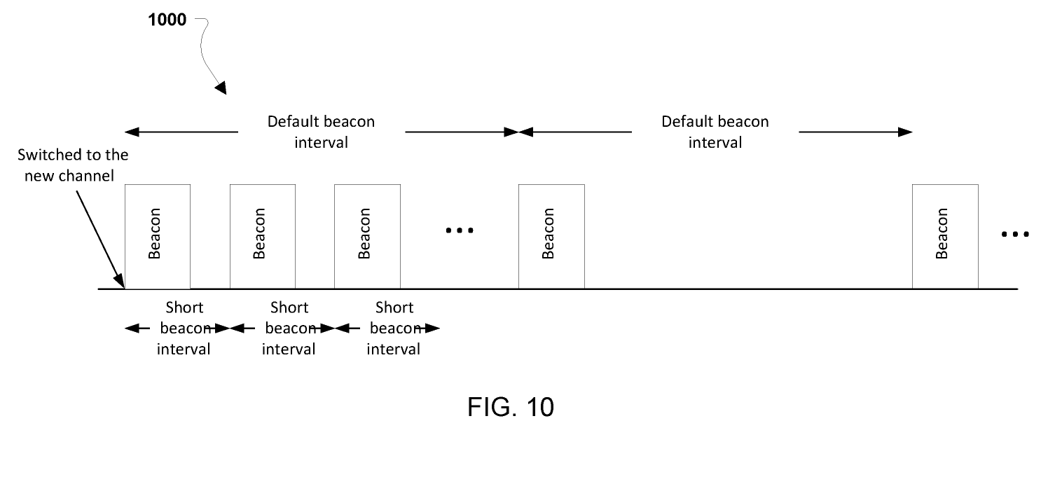

With reference to FIGS. 1-10, upon switching to the target channel, the UAV Wi-Fi module starts sending beacons right away at every short beacon interval (i.e., “SHORT_BEACON_INTERVAL”) for a duration (e.g. the default beacon interval 1000 of 100 ms), after which the default beacon interval will be resumed.

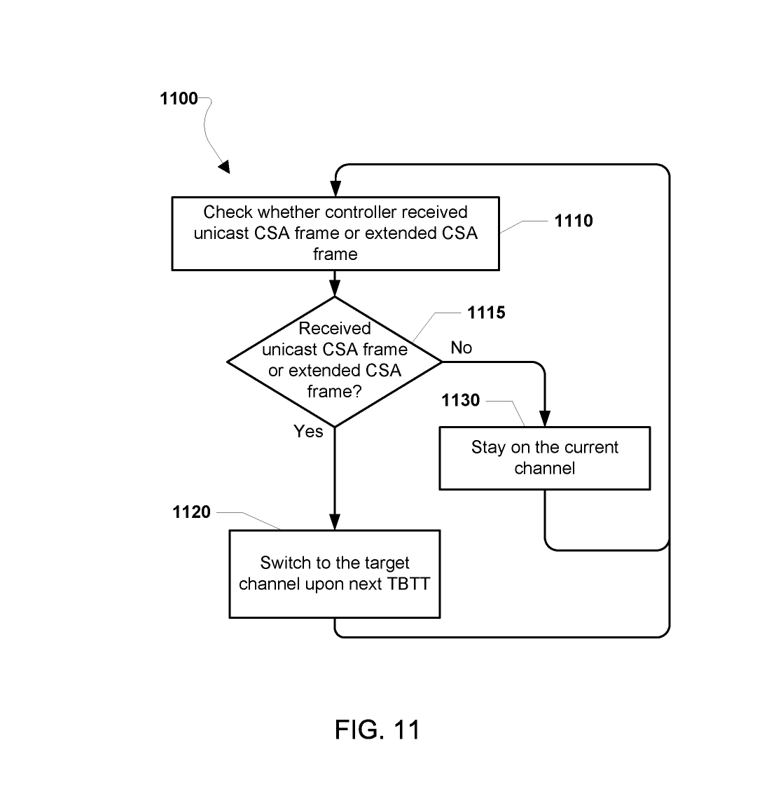

FIG. 11 illustrates a method 1100 of managing wireless communications between a UAV and a controller of the UAV. With reference to FIGS. 1-11, the operations of the method 1100 may be implemented in a processor of the controller or transmitting radio module therein. As shown in the method 1100, upon receiving a CSA or extended CSA action frame, the controller (or alternative controller) may respond with an acknowledgement and switch to the new channel upon the next TBTT and resume the uplink data transfer without the need to re-associate with the UAV. After switching to the new channel, the UAV Wi-Fi module may reset its states (CW, retry counter, etc.) and resume the beacon and data transfer. In addition, after switching to the new channel, the controller Wi-Fi module may reset its states (CW, retry counter, etc.) and resume the data transfer.

In block 1100, the processor of the controller may check whether controller received unicast CSA frame or extended CSA frame. In determination block 1115, the processor determines whether the controller received a unicast CSA frame or extended CSA frame.

In response to the processor determining the controller received a unicast CSA frame or extended CSA frame (i.e., determination block 1115=“Yes”), the processor may switch to the target channel upon the next TBTT in block 1120 and return to block 1110 to again check whether controller received unicast CSA frame or extended CSA frame.

In response to the processor determining that the controller did not receive a unicast CSA frame or extended CSA frame (i.e., determination block 1115=“No”), the processor may stay on the current channel in block 1130 and return to block 1110 to again check whether controller received unicast CSA frame or extended CSA frame.

While various embodiments are described for a moving transmitting device transmitting to a stationary receiving device, such as will often be the case for a UAV (e.g., 10) communicating with a ground-based controller (e.g., receiving device 12), the various embodiments apply equally well to situations in which the transmitting device is stationary and the receiving device is moving, as well as situations in which both the transmitting and receiving devices are moving independently.

Various embodiments illustrated and described are provided merely as examples to illustrate various features of the claims. However, features shown and described with respect to any given embodiment are not necessarily limited to the associated embodiment and may be used or combined with other embodiments that are shown and described. Further, the claims are not intended to be limited by any one example embodiment.

The foregoing method descriptions and the process flow diagrams are provided merely as illustrative examples and are not intended to require or imply that the steps of the various embodiments must be performed in the order presented. As will be appreciated by one of skill in the art the order of operations in the foregoing embodiments may be performed in any order. Words such as “thereafter,” “then,” “next,” etc. are not intended to limit the order of the operations; these words are used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm operations described in connection with the embodiments disclosed herein may be implemented as electronic hardware, computer software, or combinations of both. To clearly illustrate this interchangeability of hardware and software, various illustrative components, blocks, modules, circuits, and operations have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the claims.

The hardware used to implement the various illustrative logics, logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of receiver smart objects, e.g., a combination of a DSP and a microprocessor, a plurality of microprocessors, one or more microprocessors in conjunction with a DSP core, or any other such configuration. Alternatively, some operations or methods may be performed by circuitry that is specific to a given function.

In one or more aspects, the functions described may be implemented in hardware, software, firmware, or any combination thereof. If implemented in software, the functions may be stored as one or more instructions or code on a non-transitory computer-readable storage medium or non-transitory processor-readable storage medium. The operations of a method or algorithm disclosed herein may be embodied in a processor-executable software module or processor-executable instructions, which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable storage media may include RAM, ROM, EEPROM, FLASH memory, CD-ROM or other optical disk storage, magnetic disk storage or other magnetic storage smart objects, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable storage medium and/or computer-readable storage medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the present disclosure is not intended to be limited to the embodiments shown herein but is to be accorded the widest scope consistent with the following claims and the principles and novel features disclosed herein.

What is claimed is:

1. A method of managing wireless communications between an unmanned aerial vehicle (UAV) and a controller of the UAV, comprising:
determining whether an indicator of current channel conditions for wireless communications over a first channel equals or exceeds a channel impairment threshold, wherein the indicator of current channel conditions includes at least one of a Doppler speed or a distance between the UAV and the controller; and
changing from the first channel to a second channel for the wireless communications in response to determining that the indicator of current channel conditions for the wireless communications over the first channel equals or exceeds the channel impairment threshold.

2. The method of claim 1, further comprising:
determining a location of at least one of the UAV and the controller, wherein the Doppler speed or the distance between the UAV and the controller is determined based on the determined location of the at least one of the UAV and the controller.

3. The method of claim 1, further comprising:
receiving sensor data from a UAV sensor providing a measure of current channel conditions; and
determining the Doppler speed or the distance between the UAV and the controller based on the received sensor data.

4. The method of claim 1, further comprising:
determining, while the UAV is using a 2.4 GHz frequency band for communications, whether the Doppler speed is below a 5 GHz Doppler speed limit; and
determining whether a request-to-send (RTS) failure rate is greater than an RTS failure rate threshold or a packet failure rate is greater than a packet failure rate threshold, wherein changing from the first channel to the second channel for the wireless communications includes changing to another operating frequency band in response to determining that the Doppler speed, while the UAV is operating at the 2.4 GHz frequency band, is below the 5 GHz Doppler speed limit and the RTS failure rate is greater than the RTS failure rate threshold or the packet failure rate is greater than the packet failure rate threshold.

5. The method of claim 4, further comprising:
determining a switch count of times the first channel has been switched on the 2.4 GHz frequency band within a predetermined period, wherein changing from the first channel to the second channel is performed further in response to the determined switch count equaling or exceeding a maximum switching threshold.

6. The method of claim 1, wherein the indicator of current channel conditions includes at least one communication metric selected from the group including a request to send failure rate, a Physical Layer Convergence Procedure (PLCP) protocol data unit failure rate, a media access control protocol data unit packet error rate, an average modulation and coding scheme, or received signal strength indicator.

7. The method of claim 1, further comprising:
scanning at least one channel other than the first channel; and
determining whether a condition of wireless communications over the at least one channel other than the first channel equals or exceeds the channel impairment threshold.

8. The method of claim 1, further comprising:
determining whether a channel switching counter-indicator has been detected, wherein changing the first channel of the wireless communications is further in response to not determining the channel switching counter-indicator has been detected.

9. The method of claim 8, wherein the channel switching counter-indicator includes at least one of:
a switch count that equals or exceeds a maximum switching threshold; and
a received signal strength indicator (RSSI) at the UAV that does not equal or exceed a UAV RSSI Threshold.

10. The method of claim 1, further comprising:
determining whether a received signal strength indicator (RSSI) at the UAV operating at a 5 GHz frequency band equals or exceeds a UAV RSSI threshold; and
changing from the first channel to the second channel in response to determining that the RSSI at the UAV operating at another operating frequency band equals or exceeds the UAV RSSI threshold if:
the Doppler speed of the UAV is higher than a 5 GHz Doppler speed limit;
or
an average modulation and coding scheme (MCS) is below an MCS threshold with an average packet error rate (PER) higher than a PER threshold.

11. The method of claim 1, further comprising:
transmitting information from the UAV to the controller in one or more transmission frames including at least one of a channel switch announcement (CSA) and an extended CSA element in a transmission frame.

12. The method of claim 1, further comprising:
transmitting a first series of beacon signals with a first interval therebetween for a predetermined period after which a second series of beacon signals is transmitted with a second interval therebetween that is longer than the first interval, wherein the first series of beacon signals are transmitted immediately in response to changing from the first channel to the second channel.

13. The method of claim 1, further comprising:
determining whether the controller received at least one of a channel switch announcement (CSA) and an extended CSA element, wherein changing from the first channel to the second channel for the wireless communications is further in response to determining that the controller received the at least one of the CSA and the extended CSA element.

14. An unmanned aerial vehicle (UAV), comprising:
a transceiver configured to communicate with a controller remote from the UAV; and
a processor coupled to the transceiver and configured with processor-executable instructions to:
determine whether an indicator of current channel conditions for wireless communications over a first channel equals or exceeds a channel impairment threshold, wherein the indicator of current channel conditions includes at least one of a Doppler speed or a distance between the UAV and the controller; and
change from the first channel to a second channel for the wireless communications in response to determining that the indicator of current channel conditions for the wireless communications over the first channel equals or exceeds the channel impairment threshold.

15. The UAV of claim 14, wherein the processor is further configured with the processor-executable instructions to:
determine, while the UAV is using a 2.4 GHz frequency band for communications, whether the Doppler speed is below a 5 GHz Doppler speed limit; and
determine whether a request-to-send (RTS) failure rate is greater than an RTS failure rate threshold or a packet failure rate is greater than a packet failure rate threshold, wherein changing from the first channel to the second channel for the wireless communications includes changing to another operating frequency band in response to determining that the Doppler speed, while the UAV is operating at the 2.4 GHz frequency band, is below the 5 GHz Doppler speed limit and the RTS failure rate is greater than the RTS failure rate threshold or the packet failure rate is greater than the packet failure rate threshold.

16. The UAV of claim 14, wherein the processor is further configured with the processor-executable instructions such that the indicator of current channel conditions includes at least one communication metric selected from the group including a request to send failure rate, a Physical Layer Convergence Procedure (PLCP) protocol data unit failure rate, a media access control protocol data unit packet error rate, an average modulation and coding scheme, or received signal strength indicator.

17. The UAV of claim 14, wherein the processor is further configured with the processor-executable instructions to:
scan at least one channel other than the first channel; and
determine whether a condition of wireless communications over the at least one channel other than the first channel equals or exceeds the channel impairment threshold.

18. The UAV of claim 14, wherein the processor is further configured with the processor-executable instructions to:
determine whether a channel switching counter-indicator has been detected, wherein changing the first channel of the wireless communications is further in response to not determining the channel switching counter-indicator has been detected.

19. A method of managing wireless communications between an unmanned aerial vehicle (UAV) and a controller of the UAV, comprising:
determining whether an indicator of current channel conditions for wireless communications over a first channel equals or exceeds a channel impairment threshold, wherein the indicator of current channel conditions includes at least one of a Doppler speed or a distance between the UAV and the controller; and
adjusting a characteristic of application traffic communicated over the first channel in response to determining that the indicator of current channel conditions for the wireless communications over the first channel equals or exceeds the channel impairment threshold.

20. The method of claim 19, wherein adjusting the characteristic of application traffic includes at least one of changing a target bitrate, resolution, quality, or frame rate of video captured by a camera on the UAV and communicated to the controller in real time.

21. The method of claim 19, wherein adjusting the characteristic of application traffic includes changing a maximum throughput rate of application traffic communicated over the first channel.

22. The method of claim 19, further comprising:
determining a location of at least one of the UAV and the controller, wherein the Doppler speed or the distance between the UAV and the controller is determined based on the determined location of the at least one of the UAV and the controller.

23. The method of claim 19, further comprising:
receiving sensor data from a UAV sensor providing a measure of current channel conditions; and
determining the Doppler speed or the distance between the UAV and the controller based on the received sensor data.

24. The method of claim 19, further comprising:
determining whether a received signal strength indicator (RSSI) at the UAV operating at a 5 GHz frequency band equals or exceeds a UAV RSSI threshold, wherein adjusting the characteristic of application traffic is in response to determining that the RSSI at the UAV operating at another operating frequency band equals or exceeds the UAV RSSI threshold if:
the Doppler speed of the UAV is higher than a 5 GHz Doppler speed limit; or
an average modulation and coding scheme (MCS) is below an MCS threshold with an average packet error rate (PER) higher than a PER threshold.

25. An unmanned aerial vehicle (UAV), comprising:
a transceiver configured to communicate with a controller remote from the UAV; and
a processor coupled to the transceiver and configured with processor-executable instructions to:
determine whether an indicator of current channel conditions for wireless communications over a first channel equals or exceeds a channel impairment threshold, wherein the indicator of current channel conditions includes at least one of a Doppler speed or a distance between the UAV and the controller; and
adjust a characteristic of application traffic communicated over the first channel in response to determining that the indicator of current channel conditions for the wireless communications over the first channel equals or exceeds the channel impairment threshold.

26. The UAV of claim 25, wherein the processor is further configured with the processor-executable instructions such that adjusting the characteristic of application traffic includes at least one of changing a target bitrate, resolution, quality, or frame rate of video captured by a camera on the UAV and communicated to the controller in real time.

27. The UAV of claim 25, wherein the processor is further configured with the processor-executable instructions such that adjusting the characteristic of application traffic includes changing a maximum throughput rate of application traffic communicated over the first channel.

28. The UAV of claim 25, wherein the processor is further configured with the processor-executable instructions to:
determine a location of at least one of the UAV and the controller, wherein the Doppler speed or the distance between the UAV and the controller is determined based on the determined location of the at least one of the UAV and the controller.

29. The UAV of claim 25, wherein the processor is further configured with the processor-executable instructions to:
receive sensor data from a UAV sensor providing a measure of current channel conditions; and
determine the Doppler speed or the distance between the UAV and the controller based on the received sensor data.

30. The UAV of claim 25, wherein the processor is further configured with the processor-executable instructions to:
determine whether a received signal strength indicator (RSSI) at the UAV operating at a 5 GHz frequency band equals or exceeds a UAV RSSI threshold, wherein adjusting the characteristic of application traffic is in response to determining that the RSSI at the UAV operating at another operating frequency band equals or exceeds the UAV RSSI threshold if:
the Doppler speed of the UAV is higher than a 5 GHz Doppler speed limit; or
an average modulation and coding scheme (MCS) is below an MCS threshold with an average packet error rate (PER) higher than a PER threshold.
